(19) United States
(12) Patent Application Publication
(10) Pub. No.: US 2024/0198590 A1
(43) Pub. Date: Jun. 20, 2024

(54) APPARATUS AND METHODS FOR MAKING THREE-DIMENSIONAL OBJECTS USING A HEATED RECOATER

(71) Applicant: Gulf Filtration Systems Inc., Burlington, MA (US)

(72) Inventors: Mohamad Janbain, Oberhausen (DE); Alexandr Shkolnik, Los Angeles, CA (US); Kirin Xu, Aliso Viejo, CA (US)

(21) Appl. No.: 18/539,815

(22) Filed: Dec. 14, 2023

Related U.S. Application Data
(60) Provisional application No. 63/432,636, filed on Dec. 14, 2022.

(51) Int. Cl. B29C 64/295; B29C 64/214; B29C 64/25; B29C 64/393; B33Y 10/00; B33Y 30/00; B33Y 50/02

(52) U.S. Cl. CPC B29C 64/295; B29C 64/214; B29C 64/25; B29C 64/393; B33Y 10/00; B33Y 30/00; B33Y 50/02

(57) ABSTRACT

A recoater for an apparatus for making at three-dimensional object from a solidifiable material shown and described. The recoater traverses an exposed surface of the solidifiable material to planarize it before forming each object layer. Techniques for improving the flow of solidifiable material over the most recently formed object surface are described. In accordance with one technique, the recoater has a plurality of heaters embedded in its body along its length. The heaters are operable to heat the recoater, and thus, the solidifiable material, thereby reducing its viscosity relative to its viscosity at standard conditions, such as 25° C. In accordance with another technique, a plurality of ultrasonic transducers are provided along the recoater length and are operable to supply ultrasonic energy to the solidifiable material to reduce its viscosity. Recoaters operating at positive pressure and subatmospheric pressure are described.

### CROSS-REFERENCE TO RELATED APPLICATIONS

This application claims the benefit of U.S. Provisional Application No. 63/432,636, filed on Dec. 14, 2022, the entirety of which is hereby incorporated by reference.

### FIELD

This disclosure relates to an apparatus and method for making three-dimensional objects from a photopolymeric resin using a recoater, and more specifically a recoater that is heated and/or otherwise configured to recoat high viscosity resins.

### BACKGROUND

Three-dimensional rapid prototyping and manufacturing allows for quick and accurate production of components at high accuracy. Machining steps may be reduced or eliminated using such techniques and certain components may be functionally equivalent to their regular production counterparts depending on the materials used for production.

The components produced may range in size from small to large parts. The manufacture of parts may be based on various technologies including photopolymer hardening using light or laser curing methods. Secondary curing may take place with exposure to, for example, ultraviolet (UV) light. A process to convert a computer aided design (CAD) data to a data model suitable for rapid manufacturing may be used to produce data suitable for constructing the component. Then, a pattern generator may be used to construct the part. An example of a pattern generator may include the use of DLP (Digital Light Processing technology) from Texas Instruments®, SXRD™ (Silicon X-tal Reflective Display), LCD (Liquid Crystal Display), LCOS (Liquid Crystal on Silicon), DMD (digital mirror device), J-ILA from JVC, SLM (Spatial light modulator) or any type of selective light modulation system. Examples of such DLP based systems are provided U.S. Pat. Nos. 8,372,330 and 8,666,142, the entirety of each of which is hereby incorporated by reference

Certain methods for making three-dimensional objects from a photopolymer resin are carried out by projecting solidification energy in the form of light from a digital light projector downward onto the exposed surface of a volume of the resin. During the build process a build platform progressively moves downward as the object is built on the build platform in an upward direction.

When performing such methods, it is typically important to ensure that the exposed surface of the solidifiable material (e.g., photocurable liquid or resin) is planar to avoid inaccuracies in the resulting three-dimensional objects. For smaller build envelopes, rigid or semi-rigid solidification substrates (e.g., glass or hard plastic) may be used alone or in conjunction with films to provide the necessary degree of planarity. However, for larger build envelopes (e.g., those exceeding about 10 inches by 15 inches (150 in.²)) this approach may not be successful. Certain technologies use a “recoating blade” or a “vacuum blade” which traverses the build envelope and controls the distribution of resin to provide a smooth exposed surface. It has been found that high viscosity resins have difficulty flowing from the interior of the recoater to apply liquid over the most recently solidified object area. In certain cases, the resin drawn into the interior of the recoater cools relative to the bulk resin temperature, and the temperature differential impedes the flow of resin from the interior of the recoater to the bulk resin. Also, it is believed that several other factors may impede the flow of high viscosity resins from the interior of the recoater, including surface tension, shear stress, displacement thickness vs momentum thickness, and recoater blade travel speed. Thus, a need has arisen for a recoater and a method of using a recoater to manufacture three-dimensional objects which addresses the foregoing difficulties.

### SUMMARY

In accordance with a first aspect of the present disclosure, a recoater for an apparatus for making three-dimensional objects from a solidifiable material is provided which comprises a front wall and a rear wall connected by an upper wall and spaced apart along a first axis, wherein the front wall, rear wall, and upper wall define a partially enclosed space having a height along a second axis, and a length along a third axis. A plurality of heaters spaced are apart along the third axis, wherein each heater is in thermal communication with at least one of the front wall and rear wall. In certain examples, the heaters are cartridge heaters embedded in the front or rear walls of the recoater. In certain other examples, the recoater is provided as part of an apparatus for making a three-dimensional object from a solidifiable material. The apparatus comprises a source of the solidifiable material defining an exposed surface of the solidifiable material, a build platform that is movable along the height axis relative to the source of the solidifiable material, and a recoating assembly comprising the recoater and a recoater drive. The recoater drive is operable to traverse the recoater along a first axis in contact with the exposed surface of the solidifiable material.

In accordance with a second aspect of the present disclosure, a method of forming a three-dimensional object is provided. The method comprises traversing a recoater blade along a first axis in contact with a solidifiable material while supplying heat to the recoater blade at one or more locations along a second axis.

### BRIEF DESCRIPTION OF THE DRAWINGS

FIG. 1 is a perspective view of an apparatus for making a three-dimensional object from a solidifiable material, shown with the printing chamber viewing window open and the resin container partially removed from the apparatus housing;

FIG. 2A is a portion of a recoating assembly which can be used with the apparatus of FIG. 1, and which comprises a recoater having a plurality of embedded cartridge heaters spaced apart along its length;

FIG. 2B is a close-up view of the recoater of FIG. 2A;

FIG. 2C is a cross-sectional view of the recoater of FIGS. 2A and 2B taken along the line 2C-2C and viewed along the y-axis;

FIG. 3 is a schematic cross-sectional view of the recoater of FIGS. 2A-2C in operation with the apparatus of FIG. 1; and

FIG. 4 is an alternative version of the recoater of FIGS. 2A-2C in which inlet ports are provided to feed solidifiable material into the interior of the recoater.

### DETAILED DESCRIPTION

The systems disclosed herein are generally used for manufacturing three-dimensional objects from a solidifiable material and rapid prototyping. A pattern generator (such as a digital light projector, laser, etc.) provides an image to the solidifiable material to selectively solidify it. In the systems described herein, a recoater is provided which traverses the exposed surface of the solidifiable material to even out the deposition of the material and to create a more planar exposed surface for solidification.

As discussed herein, a solidifiable material is a material that when subjected to energy, wholly or partially hardens. This reaction to solidification or partial solidification may be used as the basis for constructing the three-dimensional object. Examples of a solidifiable material may include a polymerizable or cross-linkable material, a photopolymer, a photo powder, a photo paste, or a photosensitive composite that contains any kind of ceramic based powder such as aluminum oxide or zirconium oxide or ytteria stabilized zirconium oxide, a curable silicone composition, silica based nanoparticles or nanocomposites. The solidifiable material may further include fillers. Moreover, the solidifiable material may take on a final form (e.g., after exposure to the electromagnetic radiation) that may vary from semi-solids, solids, waxes, and crystalline solids.

When discussing a photopolymerizable, photocurable, or solidifiable material, any material is meant, possibly comprising a resin and optionally further components, which is solidifiable by means of supply of stimulating energy such as electromagnetic radiation. Suitably, a material that is polymerizable and/or cross-linkable (i.e., curable) by electromagnetic radiation (common wavelengths in use today include UV radiation and/or visible light) can be used as such material. In an example, a material comprising a resin formed from at least one ethylenically unsaturated compound (including but not limited to (meth)acrylate monomers and polymers) and/or at least one epoxy group-containing compound may be used. Suitable other components of the solidifiable material include, for example, inorganic and/or organic fillers, coloring substances, viscose-controlling agents, etc., but are not limited thereto.

When photopolymers are used as the solidifiable material, a photoinitiator is typically provided. The photoinitiator absorbs light and generates free radicals which start the polymerization and/or crosslinking process. Suitable types of photoinitiators include metallocenes, 1,2 di-ketones, acylphosphine oxides, benzyldimethyl-ketals, α-amino ketones, and α-hydroxy ketones. Examples of suitable metallocenes include Bis (eta 5-2, 4-cyclopenadien-1-yl) Bis [2,6-difluoro-3-(1H-pyrrol-1-yl)phenyl]titanium, such as Irgacure 784, which is supplied by Ciba Specialty chemicals. Examples of suitable 1,2 di-ketones include quinones such as camphorquinone. Examples of suitable acylphosphine oxides include bis acyl phosphine oxide (BAPO), which is supplied under the name Irgacure 819, and mono acyl phosphine oxide (MAPO) which is supplied under the name Darocur® TPO. Both Irgacure 819 and Darocur® TPO are supplied by Ciba Specialty Chemicals. Examples of suitable benzyldimethyl ketals include alpha, alpha-dimethoxy-alpha-phenylacetophenone, which is supplied under the name Irgacure 651. Suitable α-amino ketones include 2-benzyl-2-(dimethylamino)-1-[4-(4-morpholinyl)phenyl]-1-butanone, which is supplied under the name Irgacure 369. Suitable α-hydroxy ketones include 1-hydroxy-cyclohexyl-phenyl-ketone, which is supplied under the name Irgacure 184 and a 50-50 (by weight) mixture of 1-hydroxy-cyclohexyl-phenyl-ketone and benzophenone, which is supplied under the name Irgacure 500.

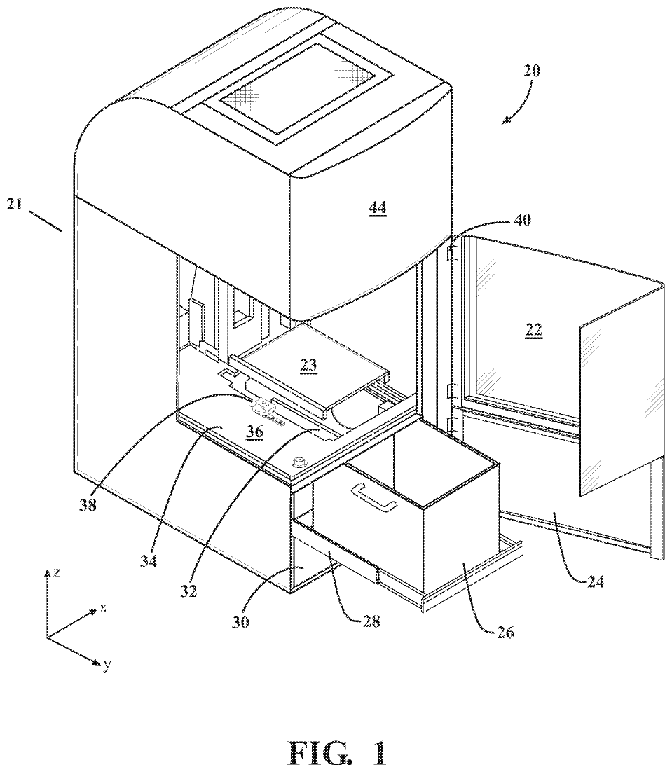

Referring to FIGS. 1-4, an example of a system 20 for making a three-dimensional object from a solidifiable material is described. System 20 is generally configured to receive data describing the shape and appearance of the object (such as CAD data) and to create a solid object from a solidifiable material in conformity with the data. System 20 includes a solidifiable material (not shown), which in the example of FIG. 1A is a photopolymeric resin capable of being selectively hardened by the application of electromagnetic radiation. Container 26 is a generally rigid vessel with an empty interior that holds solidifiable material. A build platform 23 is a generally rigid platform having a length along the y-axis and a width along the x-axis on which a three-dimensional object is progressively built along a height (z) axis. Build platform 23 defines a “build envelope” which is an area in the x-y plane in which a three-dimensional object may be built.

System 20 includes a housing 21 for supporting and enclosing the components of system 20. Housing 21 includes a viewing window 22 that is moveably disposed in a housing opening to selectively enclose a printing chamber 33. Viewing window 22 allows users to observe an object as it is being built within printing chamber 33 during an object build operation. Viewing window 22 is mounted on a hinge 40 (FIG. 8), allowing the window 22 to be pivotally opened and closed about the longitudinal axis of hinge 40, thereby providing access to the printing chamber 33 and the built object once the build operation is complete.

Housing 21 also includes a lower compartment 30 for housing a photopolymer resin container 26. Photopolymer resin container 26 is mounted on a sliding support assembly 28 that allows container 26 to be slidably inserted and removed from lower compartment 30. The sliding support assembly 28 provides a means for adding or removing photopolymer resin from container 26 or for replacing container 26.

In addition, housing 21 includes an upper compartment (not shown) which is accessed via upper door 45. The upper compartment houses one or more pattern generators (not shown). In a preferred example, the one or more pattern generators comprise one or more digital light projectors. Build platform 23 is connected to elevator assembly 37 which moves build platform 23 downward into resin container 26 during an object build operation and upward out of resin container 26 after an object build operation is complete. As indicated in FIG. 1, build platform 23 has a rest position in which it is elevated above work table 36 to facilitate the removal of finished objects as well as the removal of any excess resin on platform 23.

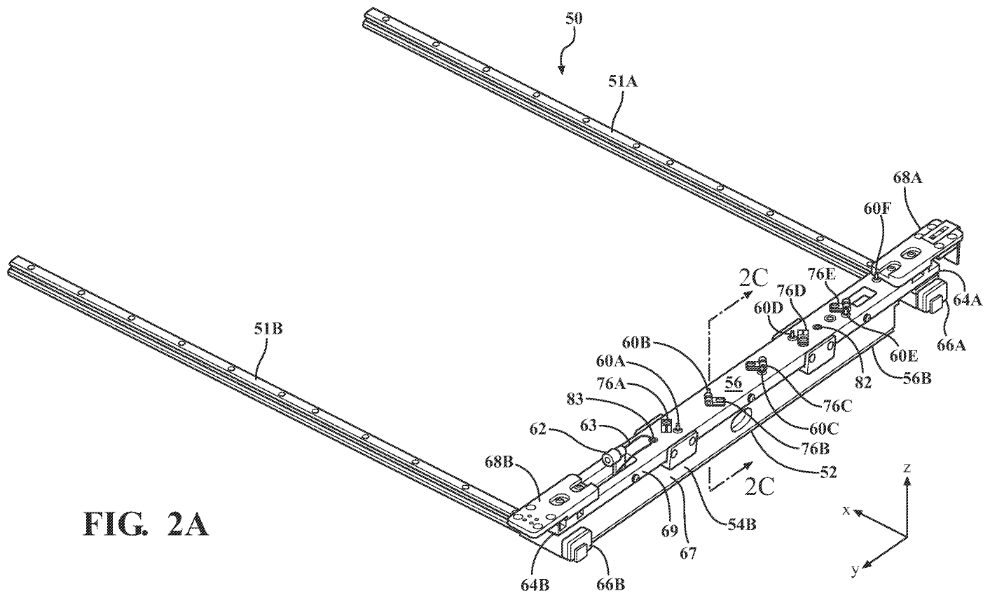

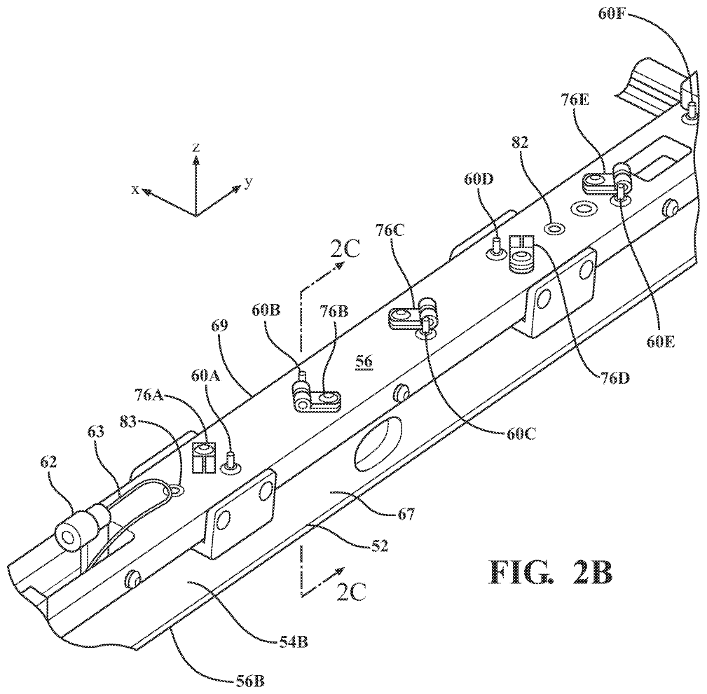

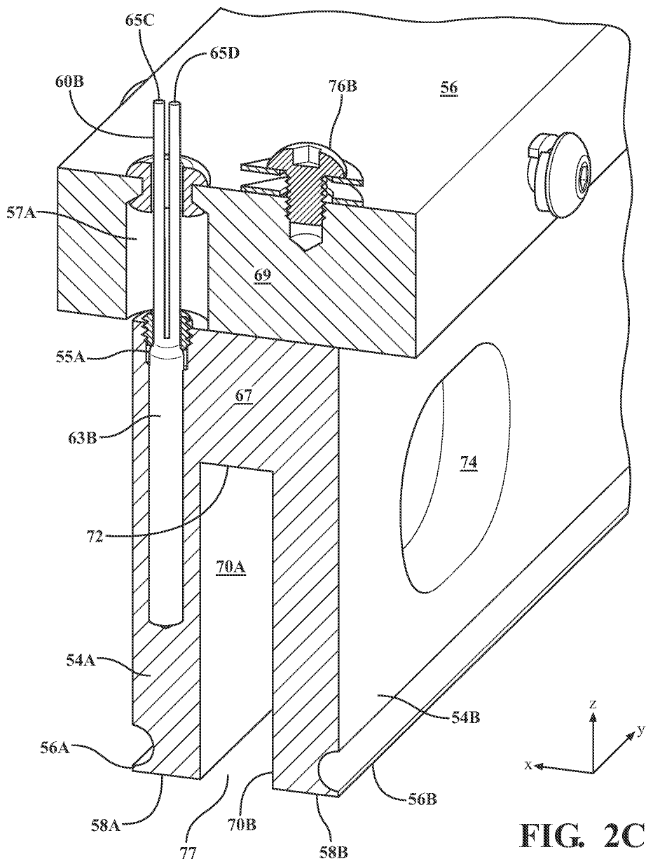

Although not shown in FIG. 1, system 20 includes a recoating system for depositing solidifiable material onto an exposed surface of a previously formed object layer and planarizing an exposed surface of the solidifiable material prior to solidifying it to form the next object layer. Referring to FIG. 2A, a portion of a recoating assembly 50 is shown. Recoating assembly 50 includes recoater 52, which is an elongated rectangular, thin box-like structure (or “blade”) having a length along the y-axis. A lower body 67 is defined by front and rear walls 54A and 54B and upper wall 72 (FIGS. 2C and 4). “Front” and “rear” are relative terms used to indicate that the walls are spaced apart along the direction of travel (x-axis) of recoater 52.

Lower body 67 is preferably made of a thermally conductive material such as a conductive metal. An upper body 69 is similarly constructed and connected to lower body 67 so as to be in thermal communication with it. The term “thermal communication” refers to the fact that heat can be transferred from lower body 67 to upper body 69 and vice-versa by thermal conduction.

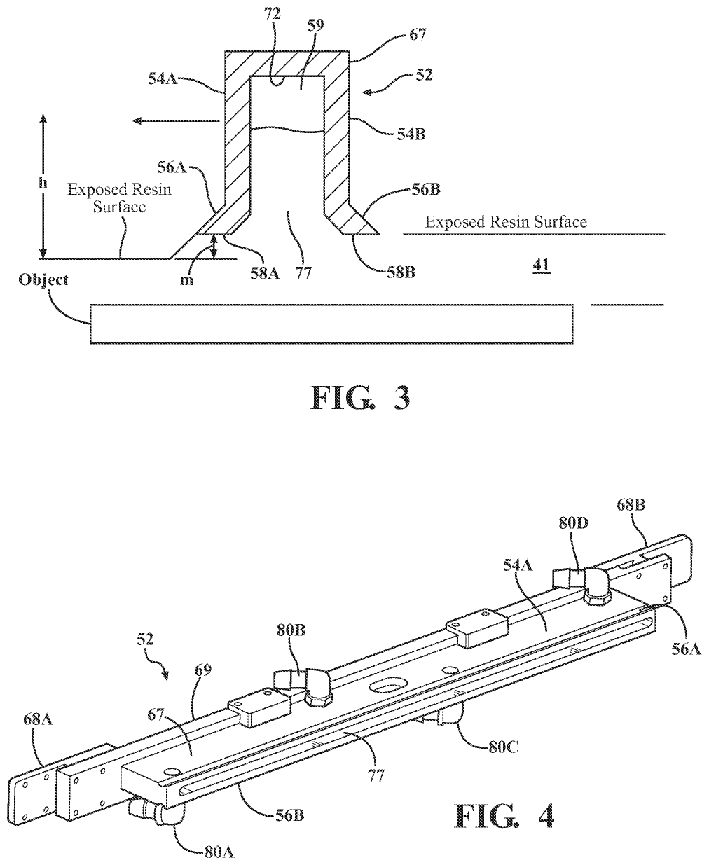

Front wall 54A is generally perpendicular to the x-y plane and includes a lip 56A and a bottom surface 58A. Rear wall 54B is also generally perpendicular to the x-y plane and includes a bottom surface 58B and a lip 56B. Lips 56A and 56B are spaced apart from upper wall 72 along the height (z) axis and extend in a direction away from one another along the recoater travel (x) axis. Although not visible in the figures, recoater 52 also includes first and second end walls which are spaced apart along the y-axis, and which each connect front wall 54A and rear wall 54B. The end walls also include bottom surfaces that are coplanar with bottom surfaces 58A and 58B of front and rear walls 54A and 54B. When recoater 52 is viewed along the height (z) axis from below recoater 52, the bottom surfaces 58A and 58B and those of the end walls define a continuous bottom surface and an enclosed perimeter which surrounds an opening 77 (FIGS. 2C and 4) through which solidifiable material 41 may flow. Thus, when recoater 52 is in contact with an exposed surface of solidifiable material, as shown in FIG. 3, partially enclosed space 58 defined by font and rear walls 54A and 54B and upper wall 72 is sealed from the atmosphere. In the example of FIG. 3, space 58 is maintained at a subatmospheric pressure, causing the formation of a liquid level in partially enclosed space 58 which is above the exposed surface of the solidifiable material 41 along the height (z) axis.

System 20 includes a work table assembly which comprises a work table 36 and a recoating assembly 50 (not shown in FIG. 1). As shown in FIG. 2A, recoating assembly 50 comprises a pair of rails 51A and 51B which would be installed on work table 36 and spaced apart along the y-axis. Recoater 52 slidingly engages rails 51A and 51B via linear bearings 64A and 64B. Brackets 68A and 68B are connected to opposite ends of recoater 52 along the y-axis and are attached to the linear bearings 64A and 64B, each of which engages its respective rail 51A and 51B. A drive assembly, such as a belt drive with pulleys, may be provided and connected to brackets 68A and 68B to drive the recoater 52 along the rails 51A and 51B to apply solidifiable material over the last solidified layer of the three-dimensional object prior to supplying solidification energy from a pattern generator.

FIG. 3 illustrates the operation of recoater 52 with partially enclosed space 58 being held at a subatmospheric pressure. In FIG. 3 upper body 68 is omitted. In the example of FIG. 3, partially enclosed space 58 is in fluid communication with a vacuum pump or a compressor 62 (FIGS. 2A and 2B) that includes a discharge line 63 that is in fluid communication with partially enclosed space 58 to maintain the partially enclosed space 58 at a pressure that is below atmospheric pressure (typically 14.7 psia at sea level). The maintenance of a subatmospheric pressure causes a level (shown as having a height h in FIG. 3) of solidifiable material to develop within the partially enclosed space 58 of recoater 52 relative to the exposed surface of the solidifiable material which remains at atmospheric pressure. The level of solidifiable material may be determined by well-known calculations that relate the level of vacuum to the hydrostatic head h created by the level in the partially enclosed space 58. A pressure regulator is preferably provided to maintain a desired level of vacuum in the head space above the level of solidifiable material within partially enclosed space 58. A shown in FIG. 3, a meniscus m is created between the lips 56A and 56B, and the exposed surface of the solidifiable material. The meniscus m seals the recoater 52 bottom surface defined by bottom surfaces 58A and 58B of front and rear walls 54A and 54B and the bottom surfaces of the end walls (not shown).

As discussed previously, in the systems described herein, the build platform (e.g., build platform 23 in FIG. 1) is pulled away from the exposed surface of solidifiable material after a layer of solidifiable material is solidified. This temporarily results in the most recently solidified surface of the three-dimensional object being exposed (i.e., not covered with solidifiable material) at a build (z) axis position that is offset from the exposed surface of solidifiable material elsewhere in the build envelope. Viscous solidifiable materials may take some time to flow over the solidified object so that a new layer may be created. However, when recoater 52 encounters the most recently formed object surface, fluid from the interior space 58 of the recoater 52 is deposited over the most recently formed object surface to create an even, new layer of unsolidified, solidifiable material.

Without wishing to be bound by any theory, it is believed that when recoater 52 encounters the most recently formed surface of the object, there is a sudden change in hydrostatic head in the interior space 58 of recoater 52. If the interior space 58 has a controlled vacuum pressure, the level h drops in order to maintain hydrostatic equilibrium. Thus, solidifiable material from the interior 58 is deposited onto the last formed object surface to restore equilibrium. It is further preferred that a level compensator of the type known in the art is provided to maintain the exposed surfaced of the solidifiable material at a substantially constant level as the build platform moves and solidifiable material is solidified. Thus, in certain preferred examples, the height h of solidifiable material within recoater 52 interior space 58 is at least as great as the maximum desired layer thickness to ensure that sufficient liquid is available for deposit over the last formed layer.

As shown in FIG. 3, in certain examples the lower surface of recoater 52 defined by front and rear wall bottom surfaces 58A and 58B (and those of the end walls) is spaced apart from the exposed working surface of the solidifiable material by an exposed surface spacing and is also spaced apart from the last formed layer of the three-dimensional object by an object spacing. In preferred examples, the object spacing is greater than the exposed surface spacing. The exposed surface spacing is preferably greater than zero to avoid disturbing the exposed surface as the recoater 52 moves along its travel (x) axis. At the same time, or in other cases, the exposed surface spacing is preferably no greater than that which allows the formation of a reliable meniscus m to ensure that the vacuum level within interior space 58 of recoater 52 is not disrupted. Preferred exposed surface spacings between the lower surface of recoater 52 the exposed surface of the solidifiable material are no greater than 500 microns, even more preferably no greater than 200 microns, and still more preferably no greater than 100 microns. Preferred object spacings between the lower surface of recoater 52 and the last solidified (upper) surface of the object are at least about one layer thickness, preferably at least about 1.2 layer thicknesses, and more preferably at least about 1.5 layer thicknesses. At the same time or in other examples, preferred object spacings between the lower surface of recoater 52 and the last solidified (upper) surface of the object are no greater than about 3 layer thicknesses, more preferably no greater than about 2.5 layer thicknesses, and still more preferably no greater than about 2 layer thicknesses.

It has been found that high viscosity resins have difficulty flowing from the interior 58 of the recoater 52 to apply liquid over the most recently solidified object area. In certain cases, the resin drawn into the interior 58 of recoater 52 cools relative to the bulk resin temperature, and the temperature differential impedes the flow of resin from the interior 58 of the recoater 52 to the bulk resin. Also, it is believed that several other factors may impede the flow of high viscosity resins from the interior of the recoater blade, including surface tension, shear stress, displacement thickness vs momentum thickness, and recoater blade travel speed. Thus, a need has arisen for a recoater blade and a method of using a recoater blade to manufacture three-dimensional objects which addresses the foregoing difficulties.

Referring to FIG. 2A, recoater 52 is provided with a plurality of cartridge heaters 60A-60E along its length (y-axis). In certain examples, two additional cartridge heaters are provided one between vacuum pump 62 and cartridge heater 60A and one between vacuum pump 62 and bracket 68B. As is known to those skilled in the art, a cartridge heater is a tube-shaped, industrial heating element that can be inserted into drilled holes. A cartridge heater consists of a resistance coil wound around a ceramic core that is surrounded by dielectric and encased in a metal sheath. Powered heat transferred through the coil to the sheath causes the sheath to heat up. Wire guides 76A-76B are also provided proximate a corresponding one of cartridge heaters 60A-60B to secure wires connected to a power source that is operable to cause the cartridge heaters 60A-60B to generate heat.

Each cartridge heater 60A-60E is embedded in one of the front wall 54A and rear wall 54B. Because the cartridge heaters 60A-60F are embedded in the thermally conductive walls 54A and 54B, they will transmit heat to the walls 54A and 54B which may then be conducted to upper body 69. When moving along the length (y-axis) of recoater 52, each successive cartridge heater from among the plurality of cartridge heaters 60A-60F is embedded in the opposite wall (front wall 54A or rear wall 54B) relative to the immediately preceding and immediately succeeding cartridge heater 60A-60B. Thus, the cartridge heaters 60A-60F may be described as being arranged in adjacent pairs, wherein each pair member is embedded in an opposite wall 54A or 54B relative to the other member of the pair.

The embedding of the cartridge heaters 60A-60F is illustrated in FIG. 2C which is a cross-sectional view of recoater 52 taken along lines 2C-2C in FIGS. 2A and 2B. Cartridge heater 60B includes a body 63B and wires 65C and 65D (only a portion of which are shown). Body 63B is inserted into dowel hole 55A formed in lower body 67. The wires 65C and 65D extend through opening 57A in upper body 57 and exit upper surface 56 of upper body 57. Wires 65C and 65D may be secured by wire guide 76B and connected to a power source operable to selectively energize cartridge heater 60B. Rear wall 54A includes a window 74 which may be, for example, a clear acrylic window, to allow the viewing of the interior space 58. Window 74 is not a through hole and does not place the interior space 58 of recoater 52 in fluid communication with the atmosphere.

As seen in FIG. 2C, front walls 54A and 54C have respective inner surfaces 70A and 70B which are placed in facing opposition to one another. Heat generated by cartridge heaters 60A-60B is transferred to the surfaces 70A and 70B by conduction and from surfaces 70A and 70B to solidifiable material contained in interior space 58 by conduction, thereby heating the solidifiable material and reducing its viscosity. Another benefit to using cartridge heaters 60A-60B is the reduction of spatial variations in solidifiable material temperature which can cause undesirable spatial variations in solidification.

In accordance with certain examples, one or more temperature sensors are provided in recoater 52 to provide an indication of the temperature of recoater 52. In the example of FIGS. 2A-2C, a thermocouple is used as temperature sensor 82 and is provided in upper recoater body 69. A variety of different thermocouples may be used. In one example, a TEMPCO Model TRW00024 thermocouple serves as temperature sensor 82. In preferred examples, a temperature controller (not shown) is also provided. The temperature controller receives a temperature input signal from temperature sensor 82 and compares it to a set point. Based on the difference between the sensed temperature and the set point, the temperature controller may reduce or increase the power supplied to cartridge heaters 60A-60B to bring the sensed temperature closer to the temperature set point. The temperature controller may use known control algorithms such as on/off control, proportional integral (PI) control, or proportional, integral, derivative (PID) control. The temperature controller is preferably located remotely from recoater 52 in an electrical panel comprising part of system 20.

In certain examples, system 20 includes a process computer with a stored program that varies the temperature controller set point based on the particular solidifiable material that is being used. In one example, the computer comprises a processor and a computer readable medium having executable instructions stored thereon, wherein when executed by the processor, the instructions query a temperature set point database that relates temperature set points to solidifiable material identifiers. The query is carried out based on a user entry of a solidifiable material identifier in the process computer, which may occur, in one example, by scanning an RFID tag on a container of the solidifiable material. The temperature set point database may be a portion of larger build file database that relates solidifiable material identifiers to various build process variables. The temperatures included in the database for each solidifiable material are preferably selected to provide adequate flow of the material from the recoater 52 to the exposed object surface without being so high as to cause the solidifiable material to begin curing.

In certain examples, recoater 52 also includes a thermostat 83, which acts as a high temperature override. Thermostat 83 is operatively connected to cartridge heaters 60A-60F and is configured to sense the temperature of upper body 69 and shut off power to cartridge heaters 60A-60F if the sensed temperature exceeds the thermostat set point. Thermostat 83 has a setpoint that is generally significantly higher than the temperature controller setpoints in the temperature setpoint database because thermostat 83 acts as a safety mechanism intended to prevent overheating, for example, if temperature sensor 82 or the temperature controller fails. In certain examples, the thermostat 83 setpoint is from about 65° C. to about 85° C., preferably from about 70° C. to about 80° C., and more preferably from about 73° C. to about 77ºC. One exemplary thermostat which may be used as thermostat 83 is a KEMET Model OHD3-60B thermostat.

In accordance with another example of the present disclosure, recoater 52 may be equipped with an ultrasonic transducer. The ultrasonic transducer is used to generate ultrasonic vibration, which causes the resin viscosity to significantly drop, thereby having a similar effect as heating the resin with a heater. Ultrasonic transducers may be used in lieu of cartridge heaters 60A-60F because ultrasonic vibration itself causes heating instead of relying on heat conduction from the cartridge heaters to the solidifiable material.

As mentioned previously, in the example of FIG. 3, recoater interior space 58 is operated at a vacuum (subatmospheric pressure). The level of solidifiable material in interior space 50 (and hence the hydrostatic head, h) may be adjusted by adjusting the level of vacuum provided by vacuum pump 62. Window 74 (FIG. 2C) may be used to view the level in interior space 58 as the adjustments are made. In certain examples, the adjustment is an open loop, manual adjustment. In other examples, closed loop level control is provided. In accordance with such examples, a level sensor is provided and senses the level of solidifiable material in interior space 58, and a level controller is provided which adjusts the level of vacuum provided by vacuum pump 62 based on the sensed level to maintain the solidifiable material level in interior space 58 at a desired setpoint.

In certain cases, operating the interior 58 of recoater 52 at subatmospheric pressure can impede the flow of high viscosity resins from the recoater interior 58 to the exposed resin surface. Thus, in an alternative example illustrated by FIG. 5, recoater 52 is configured to receive fresh solidifiable material and operate at positive pressure, thereby providing continuous flow of solidifiable material. In such positive pressure examples, recoater blade 52 is provide with a vent to maintain an atmospheric pressure above the liquid level in interior space 58 (see FIG. 3). As illustrated in FIG. 4, the blade recoater lower body 67 has four inlet ports 80A-80D for resin flow but is otherwise the same as recoater 52 of FIGS. 2A-2C and includes plurality of cartridge heaters 60A-60F. In certain examples, the inlet flow rates may adjusted by making manual, open loop adjustments to the flow rate of solidifiable material coming into inlet ports 80A-D. In other examples, closed loop level control may be provided. In accordance with such examples, a level sensor is provided to sense the level of solidifiable material in the interior 58 of recoater 52, and adjusts the inlet flow of fresh solidifiable material coming into ports 80A-D. The level of the solidifiable material in recoater interior 58 is preferably maintained above the level of the bulk solidifiable material as depicted in FIG. 3, although a positive pressure is used instead of a subatmospheric pressure.

1. A recoater for an apparatus for making three-dimensional objects from a solidifiable material, comprising:
a front wall and a rear wall connected by an upper wall and spaced apart along a first axis, wherein the front wall, rear wall, and upper wall define a partially enclosed space having a height along a second axis, and a length along a third axis;
a plurality of heaters spaced apart along the third axis.

2. The recoater of claim 1, further comprising a temperature sensor in thermal communication with at least of the front wall and the rear wall.

3. The recoater of claim 2, wherein the front wall, back, wall, and upper wall define a lower body of the recoater, the recoater further comprises an upper body in thermal communication with the lower body, and the temperature sensor is embedded in the upper body.

4. The recoater of claim 2, further comprising a temperature controller operatively connected to the temperature sensor and to the heaters in the plurality of heaters, wherein the temperature controller is configured to selectively energize the plurality of heaters in the cartridge heaters based on a temperature signal received from the temperature sensor and a temperature set point.

5. The recoater of claim 1, wherein the heaters in the plurality of heaters are cartridge heaters connected to a power source and are selectively energizable to heat the at least one of the front wall and the rear wall.

6. The recoater of claim 1, wherein the front wall and the rear walls are connected by first and second end walls, and each of the front wall, rear wall, and first and second end walls have bottom surfaces that enclose an opening that is in fluid communication with the partially enclosed space.

7. The recoater of claim 1, wherein the heaters in the plurality of heaters comprise cartridge heaters, the cartridge heaters define pairs of cartridge heaters that are adjacent one another along the third axis, a first cartridge heater in each pair of cartridge heaters is embedded in one of the first and second walls, and a second cartridge heater in each pair of cartridge heaters is embedded in the other of the first and second walls.

8. An apparatus for making a three-dimensional object from a solidifiable material, comprising:
a source of the solidifiable material defining an exposed surface of the solidifiable material;
a build platform that is movable along the height axis relative to the source of the solidifiable material;
a recoating assembly comprising the recoater of claim 1 and a recoater drive, wherein the recoater drive is operable to traverse the recoater along the first axis in contact with the exposed surface of the solidifiable material.

9. The apparatus of claim 8, wherein the solidifiable material defines a solidifiable material level along the height axis in the partially enclosed space.

10. The apparatus of claim 9, wherein the solidifiable material defines a headspace above the solidifiable material level in the partially enclosed space, and the apparatus further comprises a vacuum pump in fluid communication with the headspace and operable to maintain a subatmospheric pressure in the head space.

11. The apparatus of claim 10, wherein the recoater further comprises a plurality of solidifiable material inlet ports for feeding the solidifiable material into the partially enclosed space as the recoater travels along the first axis.

12. The apparatus of claim 8, wherein as the recoater traverses along the first axis, solidifiable material from the partially enclosed space is deposited on an exposed surface of solidified solidifiable material.

13. The apparatus of claim 8, further comprising a database of solidifiable materials stored in association with a temperature set point for the temperature controller, a processor operatively connected to the temperature controller, and a computer readable medium having a set of executable steps stored thereon, wherein when executed by the processor, the executable steps cause a setpoint of the temperature controller to be set based on a solidifiable material identifier entered by a user and the temperature set point corresponding to the solidifiable material identifier in the database.

14. The apparatus of claim 8, further comprising a temperature sensor in thermal communication with at least of the front wall and the rear wall.

15. The apparatus of claim 8, wherein the front wall, back, wall, and upper wall define a lower body of the recoater, the recoater further comprises an upper body in thermal communication with the lower body, and the temperature sensor is embedded in the upper body.

16. The apparatus of claim 14, comprising a temperature controller operatively connected to the temperature sensor and to the heaters in the plurality of heaters, wherein the temperature controller is configured to selectively energize the plurality of heaters in the cartridge heaters based on a temperature signal received from the temperature sensor and a user temperature set point.

17. The apparatus of claim 8, wherein the heaters in the plurality of heaters are cartridge heaters are connected to a power source and are selectively energizable to heat the at least one of the front wall and the rear wall.

18. The apparatus of claim 8, wherein the front wall and the rear walls are connected by first and second end walls, and each of the front wall, rear wall, and first and second end walls have bottom surfaces that enclose an opening that is in fluid communication with the partially enclosed space.

19. A method of forming a three-dimensional object, comprising:
traversing a recoater along a first axis in contact with a solidifiable material while supplying heat to the recoater at one or more locations along a second axis.

20. The method of claim 19, further comprising:
receiving a solidifiable material identifier,
selecting a temperature set point corresponding to the solidifiable material identifier from a solidifiable material temperature set point database; and
adjusting a set point of a temperature controller operatively connected to one or more heaters located at the one or more locations to the selected temperature set point.
